(19) United States
(12) Patent Application Publication
(10) Pub. No.: US 2019/0119493 A1
(43) Pub. Date: Apr. 25, 2019

(54) Vegetable Oil Polyol for Flexible Polyurethane Foam and Preparation Method and Application Thereof

(71) Applicant: NANJING TECH UNIVERSITY, Nanjing (CN)

(72) Inventors: Kai GUO, Nanjing (CN); Zheng FANG, Nanjing (CN); Junjie TAO, Nanjing (CN); Wei He, Nanjing (CN); Chengkou LIU, Nanjing (CN); Jindian DUAN, Nanjing (CN); Xin LI, Nanjing (CN); Ning ZHU, Nanjing (CN); Jiangkai QIU, Nanjing (CN); Shiyu GUO, Nanjing (CN); Pingkai OUYANG, Nanjing (CN)

(21) Appl. No.: 16/221,329

(22) Filed: Dec. 14, 2018

(30) Foreign Application Priority Data
Sep. 29, 2018 (CN) 201811153269.8

(51) Int. Cl. C08L 75/08; C08K 5/09; C08K 5/1515

(52) U.S. Cl. CPC C08L 75/08; C08K 5/09; C08G 18/627; C08L 2203/14; C08K 5/1515

(57) ABSTRACT

A vegetable oil polyol for flexible polyurethane foam, a preparation method and application thereof. The method includes the following steps: (1) subjecting an epoxidized vegetable oil, a benzoylformic acid, a basic catalyst, and an inert solvent to a ring-opening reaction in a first microchannel reactor of a microchannel reaction device to obtain a vegetable oil polyol; and (2) subjecting the vegetable oil polyol obtained in the step (1), a propylene oxide and an inert solvent to an addition polymerization reaction in a second microchannel reactor of the microchannel reaction device to obtain the vegetable oil polyol for flexible polyurethane foam.

This application claims priority to Chinese Patent Application Ser. No. CN201811153269.8 filed on 29 Sep. 2018.

### TECHNICAL FIELD

The invention belongs to the technical field of chemical materials and production thereof, and particularly relates to a vegetable oil polyol for flexible polyurethane foam, a preparation method and application thereof, and the vegetable oil polyol for flexible polyurethane foam synthesized by the invention is suitable for preparing a polyurethane material.

### BACKGROUND ART

Polyurethane is a polymer having a urethane chain segment repeating structural unit prepared by reacting an isocyanate with a polyol. Polyurethane products are divided into two categories: foaming products and non-foaming products. The foaming products include flexible, rigid, and semi-rigid polyurethane foamed plastics; the non-foaming products include a coating, a binder, a synthetic leather, an elastomer, an elastic fiber and the like. Polyurethane material has excellent performance, wide application and many kinds of products. Among them, polyurethane foamed plastic is the most widely used. Flexible polyurethane foam, which refers to a flexible polyurethane foamed plastic, is a flexible polyurethane foamed plastic with certain elasticity, and is the most widely used product in polyurethane products.

There are mainly three types of polyols used in polyurethane. One is a polymer obtained by polymerizing polyol or organic amine as a starting material with ethylene oxide, propylene oxide or butylene oxide, and is referred as polyether polyol. Another modified graft polyether polyol is prepared on the basis of polyether polyol and produced by bulk polymerization of vinyl monomer in polyol. is referred as polymer polyol, and is often used in combination with polyether polyol. The third is a polyol produced by the ring-opening polymerization of tetrahydrofuran. However, with the gradually decreasing reserves of petrochemical resources, the prices of petrochemical products continue to rise and the purchase is inconvenient, which directly affects the production of products. Therefore, seeking a new resource is an important research direction of polyols in recent years so as to make products more economical and environmentally friendly while reducing dependence on petrochemical products.

Natural oils are currently recognized as the only renewable petroleum substitutes, while the performance of vegetable oil in the natural oils is most ideal. The natural polymer which can be decomposed by microorganisms can be introduced into the polyurethane material by reacting the vegetable oil polyol prepared from vegetable oil as a raw material with isocyanate, thereby achieving the purpose of biodegrading the polyurethane material. Therefore, the introduction of vegetable oil molecules into the polyurethane material by the vegetable oil polyol not only can solve the problems such as petroleum resource shortage, environmental pollution and the like, but also increases the added value of the vegetable oil product. Moreover, vegetable oil-based polyurethane materials has mechanical properties comparable to those of polyurethane materials synthesized from corresponding petrochemical-based polyols, and further has superior hydrolytic stability, resistance to thermal decomposition and thermal oxidation, and weather resistance.

However, in many processes for preparing vegetable oil polyols, petroleum-based products such as small molecule alcohol or amine compound are mostly used as ring-opening agents, which do not meet the requirements of the sustainable development strategy of green chemical industry. Moreover, these processes have the following defects: the preparation process is cumbersome, and the vegetable oil polyols produced are mostly only suitable for producing rigid polyurethane foam materials, and are not suitable for producing flexible polyurethane foam materials.

### SUMMARY OF THE INVENTION

One object of the present invention is to overcome the dependence of the current preparation of polyether polyols on petrochemical resources, and to provide a vegetable oil polyol for flexible polyurethane foam, which has a novel structure and can completely replace the traditional petrochemical polyol for preparation of polyurethane foam materials.

Another object of the present invention is to provide a method for preparing a vegetable oil polyol for flexible polyurethane foam, which overcomes the limitation of long reaction time, high energy consumption, low product quality and uncontinuous production for the production of the bio-based vegetable oil polyol by a batch process.

A final object of the invention is to provide application of the vegetable oil polyol for flexible polyurethane foam.

To achieve the above objects, the technical solution provided by the present invention is as follows:

A method for preparing a vegetable oil polyol for flexible polyurethane foam includes the following steps:
(1) subjecting an epoxidized vegetable oil, a benzoylformic acid, a basic catalyst, and an inert solvent to a ring-opening reaction in a first microchannel reactor of a microchannel reaction device to obtain a vegetable oil polyol;
(2) subjecting the vegetable oil polyol obtained in the step (1), a propylene oxide and an inert solvent to an addition polymerization reaction in a second microchannel reactor of the microchannel reaction device to obtain the vegetable oil polyol for flexible polyurethane foam.

Preferably, the method for preparing a vegetable oil polyol for flexible polyurethane foam includes the following steps:
(1) simultaneously pumping a mixed solution prepared by dissolving an epoxidized vegetable oil and a basic catalyst in an inert solvent and a mixed solution prepared by dissolving benzoylformic acid in an inert solvent into a first microchannel reactor in a microchannel reaction device and making a ring-opening reaction to obtain a reaction solution containing the vegetable oil polyol;
(2) pumping a mixed solution prepared by dissolving the reaction solution containing the vegetable oil polyol and obtained in the step (1) and propylene oxide in an inert solvent into a second microchannel reactor of the microchannel reaction device, and making an addition polymerization reaction to obtain a vegetable oil polyol for flexible polyurethane foam.

More preferably, the method for preparing a vegetable oil polyol for flexible polyurethane foam includes the following steps:
(1) separately pumping a mixed solution prepared by dissolving an epoxidized vegetable oil and a basic catalyst in an inert solvent and a mixed solution prepared by dissolving benzoylformic acid in an inert solvent into a first micromixer of a microchannel reaction device, fully mixing, then passing to a first microchannel reactor and making a ring-opening reaction to obtain a reaction solution containing a vegetable oil polyol;
(2) pumping a mixed solution, prepared by dissolving the reaction solution containing the vegetable oil polyol and obtained in the step (1) and propylene epoxide in an inert solvent, into a second micromixer of the microchannel reaction device, fully mixing, then passing to a second microchannel reactor and making an addition polymerization reaction to obtain the vegetable oil polyol for flexible polyurethane foam.

The epoxidized vegetable oil in the step (1) is any one or more of epoxidized olive oil, epoxidized peanut oil, epoxidized rapeseed oil, epoxidized cotton seed oil, epoxidized soybean oil, epoxidized coconut oil, epoxidized palm oil, epoxidized sesame oil, epoxidized corn oil or epoxidized sunflower oil; preferably epoxidized soybean oil, epoxidized cottonseed oil or epoxidized palm oil; and more preferably epoxidized soybean oil. A molar ratio of epoxy group in the epoxidized vegetable oil to benzoylformic acid is 1: (0.8-1.5), preferably 1: (1.2-1.3).

The basic catalyst in the step (1) is any one or more of sodium hydroxide, potassium hydroxide, sodium methoxide, sodium ethoxide, sodium isopropoxide, sodium n-butoxide, sodium tert-butoxide, sodium carbonate, sodium bicarbonate, potassium methoxide, potassium ethoxide, potassium isopropoxide, potassium tert-butoxide, potassium carbonate and potassium bicarbonate; preferably sodium carbonate, wherein the mass percentage of the basic catalyst in the epoxidized vegetable oil is 0.02-0.10%, preferably 0.06%.

The reaction temperature of the ring-opening reaction in the step (1) is 80° C. to 150° C., preferably 100° C. to 150° C. The reaction time is 5 min to 20 min, preferably 8 min. The volume of the first microchannel reactor is 5 mL to 15 mL, preferably 10 mL.

The molar ratio of epoxy group in the epoxidized vegetable oil in the step (1) to propylene oxide in the step (2) is 1: (10-20), preferably 1:15. The reaction temperature of the addition polymerization reaction in the step (2) is 80° C. to 150° C., preferably 130° C. The reaction time is 10 min to 25 min, preferably 20 min. The volume of the second microchannel reactor is 20 mL to 70 mL, preferably 50 mL.

A reaction effluent of the second microchannel reactor in the step (2) is separated, and an organic phase is acid washed, neutralized, separated, rotary-evaporated, and dried to obtain a vegetable oil polyol for flexible polyurethane foam.

The acid is any one or more of hydrochloric acid, sulfuric acid, and phosphoric acid, and is preferably hydrochloric acid. The concentration of the hydrochloric acid is preferably 5 wt %. The organic phase is acid washed to a pH of 6.5-7.5.

The inert solvent is any one or more of dichloromethane, benzene, dichloroethane, chloroform, n-hexane, carbon tetrachloride, and xylene, and preferably dichloromethane or dichloroethane.

The microchannel reaction device includes a first micromixer, a first microchannel reactor, a second micromixer and a second microchannel reactor which are sequentially connected by a pipe. Reaction raw materials are input into the micromixers and subsequent equipment via a pump with precise and low pulsation.

The first micromixer and the second micromixer are each independently a Y-type mixer or a Slit Plate Mixer LH25.

The first microchannel reactor and the second microchannel reactor are independently a polytetrafluoroethylene coil having an inner diameter from 0.5 mm to 1.5 mm, preferably 1.0 mm. The first microchannel reactor and the second microchannel reactor are each connected with a back pressure valve to prevent gasification.

A vegetable oil polyol for flexible polyurethane foam is obtained by the method.

The vegetable oil polyol for flexible polyurethane foam is applied in preparation of flexible polyurethane foam.

Compared with a conventional reaction system, the microchannel reaction has the advantages of high reaction selectivity, high mass and heat transfer efficiency, high reaction activity, short reaction time, high conversion rate, good safety, easy control and the like. The application of a microchannel reaction technology in the polyhydroxy compound for ring-opening of epoxidized vegetable oil can improve the reaction efficiency, control the occurrence of side reactions, and reduce energy consumption.

Beneficial effects: compared with the prior art, the advantages of the present invention are that:

the benzoylformic acid is used as a ring-opening reagent for epoxidized vegetable oil, the prepared vegetable oil polyol for flexible polyurethane foam has a novel structure and can completely replace the traditional petrochemical polyol for application to preparation of polyurethane foam materials, and the raw material is environmentally friendly and rich in source. In addition, the preparation method is in a continuous operation, the preparation process is easy to operate and control, the reaction time is short, the energy consumption is low, the reaction efficiency is improved, and the occurrence of side reactions is reduced. At the same time, the microchannel reaction device further has the characteristics that the production device is simple, easy to assemble and disassemble, and convenient to carry and move. The microchannel reaction device can be adjusted by simply increasing or decreasing the number of microchannels, and there is no “amplification effect” similar to industrial production.

### BRIEF DESCRIPTION OF THE DRAWINGS

FIG. 1 is a schematic diagram of a microchannel reaction device.

### DETAILED DESCRIPTION OF THE INVENTION

The present invention is further below in conjunction with specific examples.

Related determination methods for the vegetable oil polyol for flexible polyurethane foam and flexible polyurethane foam as prepared according to the present invention are as follows:
determining a hydroxyl value according to GB/T 12008.3-2009;
determining the viscosity according to GB/T 12008.7-2010;
determining the density of foam plastic according to GB/T 6343-2009XX;
determining the indentation strength of the foam plastic according to GB/T 20467-2006XX;
determining the tensile strength of the foam plastic according to GB/T 6344-2008XX; and
determining the tear strength of foam according to GB/T 10808-2006.

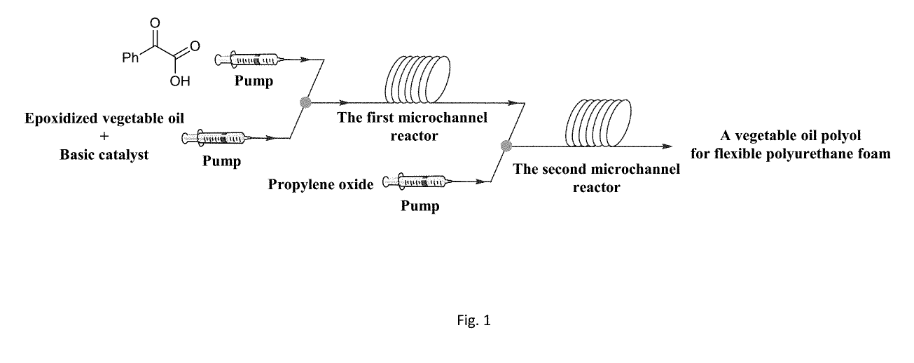

A microchannel reaction device in the following examples, as shown in FIG. 1, includes a first micromixer, a first microchannel reactor, a second micromixer, and a second microchannel reactor which are sequentially connected by a pipe. Reaction raw materials are input into the micromixers and subsequent equipment via a pump with precise and low pulsation. Among them, a first raw material storage tank (benzoylformic acid solution storage tank) is connected to a feed port of the first micromixer through the pump, a second raw material storage tank (epoxidized vegetable oil and basic catalyst solution storage tank) is connected to a feed port of the first micromixer through the pump, and a third raw material storage tank (propylene oxide solution storage tank) is connected to a feed port of the second micromixer through the pump.

The first micromixer and the second micromixer are both Y-type mixers. The first microchannel reactor and the second microchannel reactor are both polytetrafluoroethylene coils having an inner diameter of 1.0 mm and connected to a back pressure valve. The temperatures of the first microchannel reactor and the second microchannel reactor are both controlled by heating in an oil bath.

### Example 1

50.57 g of benzoylformic acid was dissolved in 600 mL of dichloromethane to obtain a mixed solution A, 100 g of epoxidized soybean oil and 0.08 g of sodium carbonate were dissolved in 600 mL of dichloroethane to obtain a solution B, and 91.58 g of propylene oxide was dissolved in 1200 mL of dichloroethane to obtain a solution C. A molar ratio of epoxy group in the epoxidized soybean oil to benzoylformic acid was 1:1.2, the mass percentage of sodium carbonate in the epoxidized soybean oil was 0.08%, and a molar ratio of epoxy group in the epoxidized soybean oil to propylene oxide was 1:15. The mixed solution A and the solution B were separately and simultaneously pumped into the first micromixer in the microchannel reaction device, fully mixed, then passed into the first microchannel reactor and subjected to a ring-opening reaction to obtain a reaction solution containing a vegetable oil polyol. The obtained reaction solution containing the vegetable oil polyol and the solution C were pumped into the second micromixer in the microchannel reaction device, fully mixed, then passed into the second microchannel reactor and subjected to an addition polymerization reaction. The volume of the first microchannel reactor was 10 mL, the reaction temperature was 100° C., and the reaction time was 8 min; and the volume of the second microchannel reactor was 50 mL, the reaction temperature was 130° C., and the reaction time was 20 min. The flow rates of the solutions A, B, and C were 0.625 mL/min, 0.625 mL/min, and 1.25 mL/min, respectively. After the completion of the reaction, a product was introduced into a separator and allowed to stand for layering to remove an aqueous solution in a lower layer. An upper organic phase was neutralized with 5 wt % hydrochloric acid to a pH value of 6.5-7.5 and separated. The organic phase was rotary-evaporated and dried to obtain a vegetable oil polyol for flexible polyurethane foam.

### Example 2

75.82 g of benzoylformic acid was dissolved in 600 mL of dichloromethane to obtain a mixed solution A, 100 g of epoxidized soybean oil and 0.02 g of sodium carbonate were dissolved in 600 mL of dichloroethane to obtain a solution B, and 61.05 g of propylene oxide was dissolved in 1200 mL of dichloroethane to obtain a solution C. A molar ratio of epoxy group in the epoxidized soybean oil to benzoylformic acid was 1:0.8, the mass percentage of sodium carbonate in the epoxidized soybean oil was 0.02%, and a molar ratio of epoxy group in the epoxidized soybean oil to propylene oxide was 1:10. The mixed solution A and the solution B were separately and simultaneously pumped into the first micromixer in the microchannel reaction device, fully mixed, then passed into the first microchannel reactor and subjected to a ring-opening reaction to obtain a reaction solution containing a vegetable oil polyol. The obtained reaction solution containing the vegetable oil polyol and the solution C were pumped into the second micromixer in the microchannel reaction device, fully mixed, then passed into the second microchannel reactor and subjected to an addition polymerization reaction. The volume of the first microchannel reactor was 10 mL, the reaction temperature was 100° C., and the reaction time was 5 min; and the volume of the second microchannel reactor was 40 mL, the reaction temperature was 80° C., and the reaction time was 10 min. The flow rates of the solutions A, B, and C were 1.0 mL/min, 1.0 mL/min, and 2.0 mL/min, respectively. After the completion of the reaction, a product was introduced into a separator and allowed to stand for layering to remove an aqueous solution in a lower layer. An upper organic phase was neutralized with 5 wt % hydrochloric acid to a pH value of 6.5-7.5 and separated. The organic phase was rotary-evaporated and dried to obtain a vegetable oil polyol for flexible polyurethane foam.

### Example 3

94.81 g of benzoylformic acid was dissolved in 600 mL of dichloromethane to obtain a mixed solution A, 100 g of epoxidized soybean oil and 0.1 g of sodium carbonate were dissolved in 600 mL of dichloroethane to obtain a solution B, and 122.11 g of propylene oxide was dissolved in 1200 mL of dichloroethane to obtain a solution C. The molar ratio of epoxy group in the epoxidized soybean oil to benzoylformic acid was 1:1.5, the mass percentage of sodium carbonate in the epoxidized soybean oil was 0.1%, and a molar ratio of epoxy group in the epoxidized soybean oil to propylene oxide was 1:20. The mixed solution A and the solution B were separately and simultaneously pumped into the first micromixer in the microchannel reaction device, fully mixed, then passed into the first microchannel reactor and subjected to a ring-opening reaction to obtain a reaction solution containing a vegetable oil polyol. The obtained reaction solution containing the vegetable oil polyol and the solution C were pumped into the second micromixer in the microchannel reaction device, fully mixed, then passed into the second microchannel reactor and subjected to an addition polymerization reaction. The volume of the first microchannel reactor was 10 mL, the reaction temperature was 150° C., and the reaction time was 20 min; and the volume of the second microchannel reactor was 25 mL, the reaction temperature was 150° C., and the reaction time was 25 min. The flow rates of the solutions A, B, and C were 0.25 mL/min, 0.25 mL/min, and 0.5 mL/min, respectively. After the completion of the reaction, a product was introduced into a separator and allowed to stand for layering to remove an aqueous solution in a lower layer. An upper organic phase was neutralized with 5 wt % hydrochloric acid to a pH value of 6.5-7.5 and separated. The organic phase was rotary-evaporated and dried to obtain a vegetable oil polyol for flexible polyurethane foam.

### Example 4

Different from Example 1, the epoxidized vegetable oil was epoxidized cottonseed oil, and a molar ratio of epoxy group in the epoxidized cottonseed oil to benzoylformic acid was 1:1.5, a molar ratio of epoxy group in the epoxidized cottonseed oil to propylene oxide was 1:12, and the mass percentage of sodium carbonate in the epoxidized cottonseed oil was 0.05%.

### Example 5

Different from Example 1, the epoxidized vegetable oil was epoxidized palm oil, a molar ratio of epoxy group in the epoxidized palm oil to benzoylformic acid was 1:1.3, a molar ratio of epoxy group in the epoxidized palm oil to propylene oxide was 1:15, and the mass percentage of sodium carbonate in the epoxidized palm oil was 0.06%.

### Example 6 Preparation of Flexible Polyurethane Foam

A formula of flexible polyurethane foam includes the following components in parts by weight: 100 parts of vegetable oil polyol for flexible polyurethane foam; 8 parts of ethylene glycol; 0.5 part of B8681 (stabilizer); 1 part of water; 1 part of triethylene diamine; and 1.0 part of toluene diisocyanate.

A preparation method includes the following steps: weighing the above components in parts by weight, mixing thoroughly and uniformly at 25° C. (except for toluene diisocyanate), adding the stoichiometric toluene diisocyanate, stirring for 10 s, pouring into a foaming box to freely foam, and aging to obtain a conventional flexible polyurethane foam.

Table 1 shows performance indexes of the vegetable oil polyol for flexible polyurethane foam prepared in Examples 1 to 5. The flexible polyurethane foams were prepared using the vegetable oil polyol for flexible polyurethane foam obtained in Examples 1 to 5, and performance indexes of the obtained products are shown in Table 2.

TABLE 1
Performance indexes of vegetable oil polyol for
flexible polyurethane foam

| Performance | | | | | |
|---|---|---|---|---|---|
| indexes | Example 1 | Example 2 | Example 3 | Example 4 | Example 5 |
| Hydroxyl | 31 | 38 | 42 | 38 | 46 |
| value | | | | | |
| mgKOH/g | | | | | |
| Viscosity | 860 | 812 | 648 | 960 | 760 |
| mPas/25° C. | | | | | |

TABLE 2
Performance indexes of polyurethane foam

| Test item | Example 1 | Example 2 | Example 3 | Example 4 | Example 5 |
|---|---|---|---|---|---|
| Density | 41.5 | 38.5 | 52.2 | 33 | 30.2 |
| (kg/m³) | | | | | |
| Indentation | 136 | 113 | 85 | 106 | 105.5 |
| strength | | | | | |
| (25% IFD, | | | | | |
| N) | | | | | |
| Tensile | 116 | 108 | 120 | 103 | 121 |
| strength kPa | | | | | |
| Elongation at | 127 | 115 | 131 | 135 | 144 |
| break % | | | | | |
| Resilience | 61 | 43 | 51 | 58 | 39 |
| by ball | | | | | |
| rebound % | | | | | |
| Tear strength | 412 | 372 | 351 | 364 | 410 |
| N/m | | | | | |
| Surface | 46 | 51 | 45 | 48 | 60 |
| hardness | | | | | |

### Example 7

Example 7 was carried out in the same way as Example 1, except that the epoxidized soybean oil was replaced with an epoxidized olive oil, the sodium carbonate was replaced with sodium hydroxide, the dichloromethane was replaced with chloroform, and dichloroethane was replaced with n-hexane. The obtained vegetable oil polyol for flexible polyurethane foam was detected to have similar properties to the vegetable oil polyol for flexible polyurethane foam and obtained in Example 1.

### Example 8

Example 8 was carried out in the same way as Example 1, only except that the epoxidized soybean oil was replaced with epoxidized peanut oil, and the sodium carbonate was replaced with sodium methoxide. A product obtained was detected to have similar properties to the product obtained in Example 1. The obtained vegetable oil polyol for flexible polyurethane foam was detected to have similar properties to the vegetable oil polyol for flexible polyurethane foam and obtained in Example 1.

### Example 9

Example 9 was carried out in the same way as Example 1, only except that the epoxidized soybean oil was replaced with epoxidized rapeseed oil, and the sodium carbonate was replaced with sodium tert-butoxide. A product obtained was detected to have similar properties to the product obtained in Example 1. The obtained vegetable oil polyol for flexible polyurethane foam was detected to have similar properties to the vegetable oil polyol for flexible polyurethane foam and obtained in Example 1.

### Example 10

Example 10 was carried out in the same way as Example 1, only except that the epoxidized soybean oil was replaced with epoxidized corn oil, and the sodium carbonate was replaced with sodium bicarbonate. A product obtained was detected to have similar properties to the product obtained in Example 1. The obtained vegetable oil polyol for flexible polyurethane foam was detected to have similar properties to the vegetable oil polyol for flexible polyurethane foam and obtained in Example 1.

### Example 11

Example 11 was carried out in the same way as Example 1, only except that the epoxidized soybean oil was replaced with epoxidized sesame oil, and the sodium carbonate was replaced with potassium ethoxide. A product obtained was detected to have similar properties to the product obtained in Example 1. The obtained vegetable oil polyol for flexible polyurethane foam was detected to have similar properties to the vegetable oil polyol for flexible polyurethane foam and obtained in Example 1.

What is claimed is:

1. A method for preparing a vegetable oil polyol for flexible polyurethane foam, which is characterized by comprising the following steps:
(1) subjecting an epoxidized vegetable oil, a benzoylformic acid, a basic catalyst, and an inert solvent to a ring-opening reaction in a first microchannel reactor of a microchannel reaction device to obtain a vegetable oil polyol;
(2) subjecting the vegetable oil polyol obtained in the step (1), a propylene oxide and an inert solvent to an addition polymerization reaction in a second microchannel reactor of the microchannel reaction device to obtain the vegetable oil polyol for flexible polyurethane foam.

2. The method of claim 1, which is characterized by comprising the following steps:
(1) simultaneously pumping a mixed solution prepared by dissolving the epoxidized vegetable oil and the basic catalyst in the inert solvent and a mixed solution prepared by dissolving the benzoylformic acid in the inert solvent into the first microchannel reactor in the microchannel reaction device and making a ring-opening reaction to obtain a reaction solution containing the vegetable oil polyol;
(2) pumping a mixed solution prepared by dissolving the reaction solution containing the vegetable oil polyol and obtained in the step (1) and propylene oxide in the inert solvent into the second microchannel reactor of the microchannel reaction device, and making an addition polymerization reaction to obtain the vegetable oil polyol for flexible polyurethane foam.

3. The method of claim 1, which is characterized in that the epoxidized vegetable oil in the step (1) is any one or more of epoxidized olive oil, epoxidized peanut oil, epoxidized rapeseed oil, epoxidized cotton seed oil, epoxidized soybean oil, epoxidized coconut oil, epoxidized palm oil, epoxidized sesame oil, epoxidized corn oil or epoxidized sunflower oil, wherein a molar ratio of epoxy group in the epoxidized vegetable oil to benzoylformic acid is 1: (0.8-1.5), and the basic catalyst is any one or more of sodium hydroxide, potassium hydroxide, sodium methoxide, sodium ethoxide, sodium isopropoxide, sodium n-butoxide, sodium tert-butoxide, sodium carbonate, sodium bicarbonate, potassium methoxide, potassium ethoxide, potassium isopropoxide, potassium tert-butoxide, potassium carbonate and potassium bicarbonate, wherein the mass percentage of the basic catalyst in the epoxidized vegetable oil is 0.02-0.10%.

4. The method of claim 1, which is characterized in that the reaction temperature of the ring-opening reaction in the step (1) is 80° C. to 150° C., the reaction time is 5 min to 20 min, and the volume of the first microchannel reactor is 5 mL to 15 mL.

5. The method of claim 1, which is characterized in that a molar ratio of epoxy group in the epoxidized vegetable oil in the step (1) to the propylene oxide in the step (2) is 1: (10-20), the reaction temperature of the addition polymerization reaction in the step (2) is 80° C. to 150° C., the reaction time is 10 min to 25 min, and the volume of the second microchannel reactor is 20 mL to 70 mL.

6. The method of claim 1, which is characterized in that reaction effluent of the second microchannel reactor in the step (2) is separated, and an organic phase is acid washed, neutralized, separated, rotary-evaporated, and dried to obtain the vegetable oil polyol for flexible polyurethane foam.

7. The method of claim 1, which is characterized in that the inert solvent is any one or more of dichloromethane, benzene, dichloroethane, chloroform, n-hexane, carbon tetrachloride, and xylene.

8. The method of claim 1, which is characterized in that the microchannel reaction device comprises a first micromixer, a first microchannel reactor, a second micromixer and a second microchannel reactor which are sequentially connected by a pipe, and the reaction raw materials are input into the micromixers and subsequent equipment via a pump with precise and low pulsation.

9. A vegetable oil polyol for flexible polyurethane foam, wherein the vegetable oil polyol is prepared by a method of claim 1.

10. A process for utilizing for a vegetable oil polyol of claim 9, wherein the process for use the vegetable oil polyol for preparing a flexible polyurethane foam.
